(19) United States
(12) Patent Application Publication
(10) Pub. No.: US 2007/0201521 A1
(43) Pub. Date: Aug. 30, 2007

(54) LASER ELEMENT DRIVING APPARATUS

(75) Inventor: Yusaku YOSHIMATSU, Ukyo-ku, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku, Kyoto (JP)

(21) Appl. No.: 10/599,468

(22) PCT Filed: Mar. 28, 2005
(86) PCT No.: PCT/JP05/05667

§ 371 Date: Apr. 5, 2007

(30) Foreign Application Priority Data
Mar. 29, 2004 (JP) 2004-096985

(51) Int. Cl. H01S 3/00

(52) U.S. Cl. 372/38.09; 372/38.03

(57) ABSTRACT

A laser element driving apparatus includes a laser element that varies the light intensity corresponding to the current that flows thereto; a photodetection element that monitors and converts the light intensity of the laser element to electric signals; an emission control switch that controls the current that flows to the laser element; a feedback amplifier that controls the emission control switch by feeding back electric signals from the photodetection element; and an emission control switch controlling circuit that turns the emission control switch OFF when determining as abnormal a current flowing continuously to the laser element for a predetermined time from the beginning of the laser element light emission and/or that controls the emission control switch such that the current flowing to the laser element at the time of beginning of the laser element light emission is gradually increased. The laser element driving apparatus safely drives a laser element.

### TECHNICAL FIELD

The present invention relates to a laser element driving apparatus that controls the light emission (lighting) of a laser element, and more particularly relates to a laser element driving apparatus that controls the light emission of a laser element that takes into consideration safety in relation to the human eye.

### BACKGROUND ART

Digital cameras, digital videos and the like use laser elements as backlights for focusing on nighttime photographic subjects. This kind of laser element driving apparatus that controls the light emission of a laser element generally includes a laser element and a photo-detection element, which monitors and converts to electric signals the light intensity thereof, and the supply current to the laser element is controlled by feeding back the electric signal of the photo-detection element (for example, Patent Document 1). Moreover, the laser element driving apparatus intermittently supplies current to the laser element, and correspondingly causes the laser element to emit light discontinuously.

FIG. 2 is a conventional laser element driving apparatus. This laser element driving apparatus 101 includes: a laser element LD that varies the light intensity corresponding to the current that flows; a photo-detection element PD that receives the light that the laser element LD emits and generates a current corresponding to the light intensity; a voltage conversion resistor 130 that converts to voltage the current of the photo-detection element PD; a feedback amplifier 112 that controls an emission control switch 111, to be described later, by receiving at a non-inversion input terminal the voltage of the voltage conversion resistor 130 and receiving at an inversion input terminal a voltage output from an emission intensity setting voltage generator 124 for setting the emission intensity of the laser element LD; an emission control switch 111 that is a PMOS transistor to control the current that flows to the laser element LD, wherein the gate receives the output voltage of the feedback amplifier 112, and the drain is connected to the laser element LD; and a power source switch 125 that is an NPN transistor that opens and closes (becomes non-conductive, conductive) corresponding to an intermittent control signal SIG consisting of a low level and a high level, wherein the collector is connected to a power source Vdd and the emitter is connected to an inner power source VddIN. The source of the emission control switch 111 and the power source terminal of the feedback amplifier 112 are connected to the inner power source VddIN.

The operation of the laser element driving apparatus 101 will be explained next. When a low level intermittent control signal SIG is input to the power source switch 125, the power source switch 125 becomes non-conductive and no power is fed to the emission control switch 111; consequently, no current flows to the laser element LD and the laser element LD does not emit light. Meanwhile, when a high level intermittent control signal SIG is input to the power source switch 125, the power source switch 125 becomes conductive, and the inner power source VddIN becomes the predetermined power voltage. Immediately after the power source switch 125 has become conductive, no current is produced by the photo-detection element PD, and therefore the input voltage of the non-inversion input terminal of the feedback amplifier 112 is at the grounded level, and the output voltage of the feedback amplifier 112 is also at the grounded level. Consequently, the emission control switch 111 is turned on, current flows to the laser element LD, and the laser element LD emits light. Then, based on the feedback loop, when the voltage of the voltage conversion resistor 130 reaches the output voltage of the emission intensity setting voltage generator 124, a predetermined current stably flows to the laser element LD. This operation repeats corresponding to the intermittent control signals SIG.

Patent Document 1: Japan Patent Application Laid-open No. H6-326396

### DISCLOSURE OF THE INVENTION

### Problem to be Solved by the Invention

In this way, a laser elements LD, which is used in a digital camera, digital video or the like, emits light discontinuously (intermittently) by the laser element driving apparatus 101. This is in order to prevent deleterious effects on the eyes when a person is the photographic subject.

Here, the present inventor focused on the possibility that a laser element could become a continuously lit state if trouble were to occur with the intermittent control signal SIG or the like. In such a situation it would be preferable to establish a countermeasure so as not to enter a continuously lit state. Moreover, as previously stated, immediately after the power source switch 125 has become conductive, the output voltage of the feedback amplifier 112 is at the grounded level, and therefore the emission control switch 111 is turned fully on so that the maximum current flows. The present applicants focused on the possibility of light emission in which, as a result, current rushes into the laser element and the emission intensity becomes excessively large, and decided that it would be preferable to configure a countermeasure so that an excessively large emission will not occur even in this situation.

With the foregoing in view, an object of the present invention is to provide a laser element driving apparatus that prevents long-term light emission (continuous lighting) or high intensity light emission of a laser element having deleterious affect on the human eye, and that heightens safety in relation to the human eye.

### Means for Solving the Problem

In order to resolve the aforementioned problem, the laser element driving apparatus according to a preferable embodiment of the present invention comprises: a laser element that varies light intensity corresponding to a current that flows; a photo-detection element that monitors and converts to electric signals the light intensity of the laser element; an emission control switch that controls the current flowing to the laser element; a feedback amplifier that controls the emission control switch by feeding back electric signals of the photo-detection element; and an emission control switch controlling circuit that turns the emission control switch OFF when determining as abnormal a current flowing continuously to the laser element for a predetermined time from the beginning of the laser element light emission and/or that controls the emission control switch such that the current flowing to the laser element at the time of beginning of the laser element light emission is gradually increased.

Preferably, the emission control switch controlling circuit includes an emission stop switch in order to turn OFF the emission control switch by determining as abnormal a current flowing continuously to the laser element for a predetermined time from the beginning of the laser element light emission.

Moreover, preferably the emission control switch controlling circuit includes a capacitor and a light emission stop switch in order to control the emission control switch such that the current flowing to the laser element is gradually increased when the laser element begins to emit light. when the laser element begins to emit light, the emission control switch is forced to turn OFF and said capacitor is charged by turning the emission stop switch ON, and after a predetermined time has elapsed, the emission control switch is controlled by turning the emission stop switch OFF and discharging said capacitor, and then the current flowing to the laser element is gradually increased.

More preferably, this laser element driving apparatus comprises an oscillator that outputs a reference clock for counting the predetermined time from the beginning of the laser element light emission up to the determination of abnormality. This oscillator is made to stop the oscillation operation when the abnormality is determined.

### EFFECTS OF THE INVENTION

According to preferred embodiments of the present invention, the laser element driving apparatus stops the light emission of the laser element LD by turning the emission control switch OFF when the laser element has emitted light continuously for a predetermined time or more based on a trouble of an intermittent control signal or the like, and therefore the safety in relation to human eyes can be heightened by preventing abnormally continuous light to have a deleterious effect on human eyes. Moreover, the current flowing to the laser element when the laser element begins to emit light is gradually increased, and therefore light with large emission intensity is prevented from having a deleterious affect on human eyes, and the safety in relation to the human eye can be heightened. In addition, the life time of the laser element can be increased by minimizing the stress.

### BRIEF DESCRIPTION OF THE DRAWINGS

FIG. 1 is a circuit diagram of a laser element driving apparatus related to a preferable embodiment of the present invention.

FIG. 2 is a circuit diagram of a conventional laser element driving apparatus.

### EXPLANATION OF REFERENCE NUMERALS

1 Laser element driving apparatus

11 Emission control switch

12 Feedback amplifier

13 Fail-safe circuit

14 Soft start circuit

16 Emission control switch controlling circuit

17 Oscillator

18 Inner power source detection circuit

21 Intermittent control signal detection circuit

19, 22 Counter

20, 23 Flip flop circuit

24 Emission intensity setting voltage generator

25 Power source switch

28 NOR circuit

29 Emission stop switch

30 Voltage conversion resistor

38 Capacitor for soft start

LD Laser element

PD Photo-detection element

SIG Intermittent control signal

### BEST MODE FOR CARRYING OUT THE INVENTION

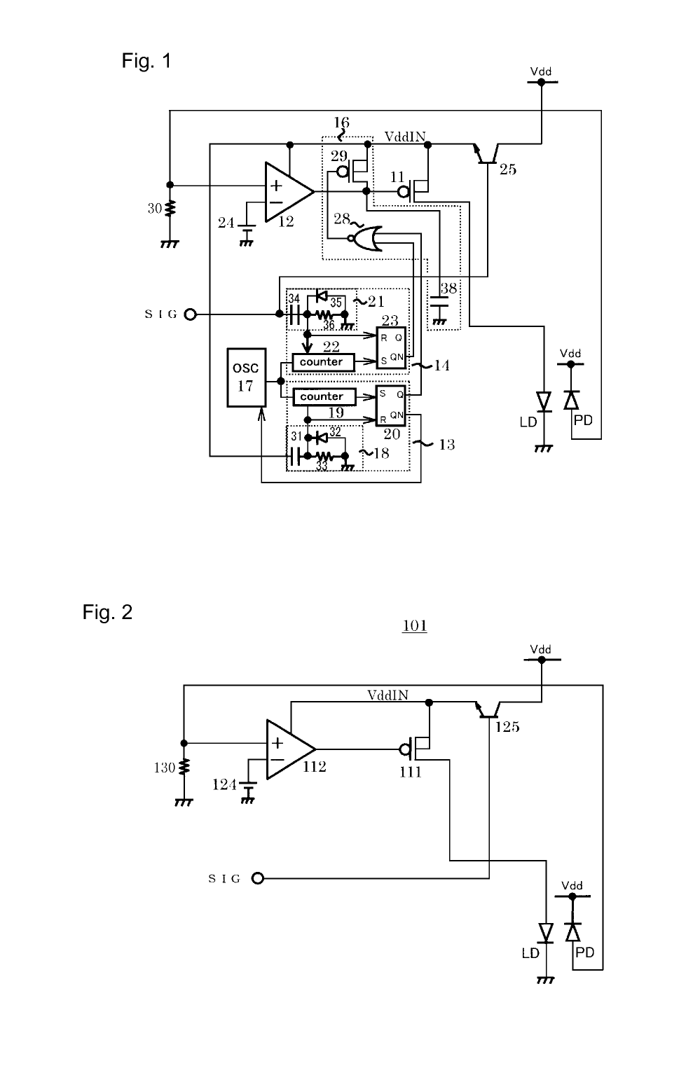

A best embodiment of the present invention will be described below while referring to the diagrams. FIG. 1 is a circuit diagram of a laser element driving apparatus related to a preferable embodiment of the present invention. In the same way as the laser element driving apparatus 101 of the prior art, this laser element driving apparatus 1 includes: a laser element LD that varies the light intensity corresponding to the current that flows; a photo-detection element PD that receives the light that the laser element LD emits and generates a current corresponding to the light intensity (specifically, monitors and converts to electric signals the light intensity of the laser element); a voltage conversion resistor 30 that converts to voltage the current of the photo-detection element PD; a feedback amplifier 12 that controls an emission control switch 11, to be described later, by receiving at a non-inversion input terminal the voltage of the voltage conversion resistor 30 (that is, feeding back the electric signal of the photo-detection element) and receiving at an inversion input terminal a voltage output from an emission intensity setting voltage generator 24 for setting the emission intensity of the laser element LD; an emission control switch 11 that is a PMOS transistor to control the current that flows to the laser element LD, wherein the gate receives the output voltage of the feedback amplifier 12, and the drain is connected to the laser element LD; and a power source switch 25 that is an NPN transistor that opens and closes (becomes non-conductive, conductive) corresponding to an intermittent control signals SIG (for example, 50% duty rectangular waveform of about 50 Hz) consisting of a low level and a high level, wherein the collector is connected to a power source Vdd and the emitter is connected to an inner power source VddIN. The source of the emission control switch 11 and the power source terminal of the feedback amplifier 12 are connected to the inner power source VddIN.

This laser element driving apparatus 1 further includes: an oscillator (OSC) 17 that outputs a reference clock (for example 40 kHz); a fail-safe circuit 13 for preventing abnormal continuous lighting, which receives the inputs of the inner power source VddIN and the reference clock; a soft start circuit 14 for preventing excessively large current from flowing to the laser element LD, which receives the inputs of the intermittent control signal SIG and the reference clock; and an emission control switch controlling circuit 16 that receives the signals from the fail-safe circuit 13 and the signals form the soft start circuit 14, and controls the emission control switch 11 based on these signals.

The fail-safe circuit 13 includes an inner power source detection circuit 18, a counter 19, and a flip flop circuit 20. The inner power source detection circuit 18 includes a capacitor 31 and resistor 33, which form a differentiation circuit, and a diode 32 that clamps the output voltage thereof. The inner power source VddIN is input to one end of the capacitor 31 as a signal. The other end of the capacitor 31 is connected to one end of the resistor 33 and the cathode of the diode 32. The other end of the resistor 31 and the anode of the diode 32 are grounded. Then, the capacitor 31 and the resistor 33, which form a differentiation circuit, detect a rise of the inner power source VddIN, and generate a one shot pulse synchronized thereto, which are output to the counter 19 and the reset input terminal R of the flip flop circuit 20. The diode 32 is for the purpose of not applying an excessively large load on the circuit receiving the output voltage by clamping the output voltage in the negative direction, which is produced synchronously with the fall of the inner power source VddIN, at the voltage below the ground potential by a Schottky barrier voltage (VF).

The one shot pulse of the inner power source detection circuit 18, as a count start signal, is input to the counter 19 of the fail-safe circuit 13, which counts the number of the reference clock of the oscillator 17. Then, when the predetermined count number (for example, a count of about 4000) is reached, a signal is output to the set input terminal S of the flip flop circuit 20 to be explained below. The flip flop circuit 20 has a reset input terminal R and a set input terminal S as input terminals, and has a non-inversion output terminal Q and an inversion output terminal QN as output terminals. Low level is output from the non-inversion output terminal Q and high level is output from the inversion output terminal QN when a pulse is input to the reset input terminal R. High level is output from the non-inversion output terminal Q and low level is output from the inversion output terminal QN when a pulse is input to the set input terminal S. The signal of the non-inversion output terminal Q is input to one input terminal of the NOR circuit 28, to be described later, of the emission control switch controlling circuit 16. The signal of the inversion output terminal QN is input to the oscillator 17, the oscillator 17 is oscillated if the signal is high level, and the oscillation is stopped if the signal is low level.

The circuit configuration of the soft start circuit 14 will be explained next. The soft start circuit 14 includes an intermittent control signal detection circuit 21, a counter 22, and a flip flop circuit 23. The intermittent control signal detection circuit 21 is a circuit configured in the same way as the inner power source detection circuit 18. That is, the intermittent control signal detection circuit 21 includes a capacitor 34 and a resistor 36, which form a differentiation circuit, and a diode 35 that clamps the output voltage thereof. Then, a capacitor 34 and a resistor 35, which form a differentiation circuit, detect a rise of the intermittent control signal SIG, and generate a one shot pulse synchronized thereto, which are output to the counter 22 and reset input terminal R of the flip flop circuit 23.

The one shot pulse of the intermittent signal detection circuit 21, as a count start signal, is input to the counter 22 of the soft start circuit 14, which counts the number of the reference clock of the oscillator 17. Then, when the predetermined count number (for example, a count of about 4) is reached, a signal is output to the set input terminal S of the flip flop circuit 23 to be explained below. The flip flop circuit 23 is a circuit that conducts the same function as the flip flop circuit 20 of the previously described fail-safe circuit 13. The signal of the inversion output terminal QN is input to the other input terminal of the NOR circuit 28 of the emission control switch controlling circuit 16, and the signal of the non-inversion output terminal Q is not input to anywhere.

The circuit configuration of the emission control switch controlling circuit 16 will be explained next. The emission control switch controlling circuit 16 includes: a NOR circuit 28, which receives, as previously described, the input of signals from the flip flop circuit 20 of the fail-safe circuit 13 and signals from the flip flop circuit 23 of the soft start circuit 14; an emission stop switch 29 that is a PMOS transistor, wherein the source is connected to the inner power source VddIN, and the drain is connected to the output of feedback amplifier 12; and a soft start capacitor 38, wherein one end is connected to the drain thereof, and the other is grounded. Here, the current drive capacity of the emission stop switch 29 shall be sufficiently higher than the current drive capacity of the ground side (specifically, the sink current side) of the feedback amplifier 12. According to this configuration, if either of the two signals input to the NOR circuit 28 is a high level signal, the emission stop switch 29 is turned ON, and, irrespective of the output of the feedback amplifier 12, the gate of the emission control switch 11 is forced to the power source voltage level. As a result, a current does not flow to the laser element LD, and the soft start capacitor 38 is charged to the power source voltage level. Meanwhile, if both of the two signals input to the NOR circuit 28 are low level, the emission stop switch 29 turns OFF, and therefore the gate voltage of the emission control switch 11 is determined by the status of the feedback amplifier 12 and the soft start capacitor 38. This will be explained in detail later.

The operation of the laser element driving apparatus 1 will be explained next. First, if a low level intermittent control signal SIG is input to the power source switch 25, the power source switch 25 becomes non-conductive, and no power is supplied to the emission control switch 11; consequently, no current flows to the laser element LD, and the laser element LD does not emit light.

Next, when the laser element LD begins to emit light, specifically, when a high level intermittent control signal SIG is input to the power source switch 25, the power source switch 25 becomes conductive, and the inner power source VddIN becomes the predetermined power source voltage. Then, the rising edge of the inner power source VddIN is detected by the inner power source detection circuit 18 of the fail-safe circuit 13, the flip flop circuit 20 is reset by the detection signal thereof, and the counter 19 begins counting.

Meanwhile, the rising edge of the intermittent control signal SIG is detected by the intermittent control signal detection circuit 21 of the soft start circuit 14, and the flip flop circuit 23 is reset by the detection signal and the counter 22 starts counting. When the flip flop circuit 23 of the soft start circuit 14 is reset, the high level from the inversion output QN of the flip flop circuit 23 is input to the NOR circuit 28 of the emission control switch controlling circuit 16. The NOR circuit 28 outputs low level to the emission stop switch 29, the emission stop switch 29 is turned ON, and the gate of the emission control switch 11 is forced to the power source voltage level. At that time, the emission control switch 11 is OFF (non-conductive), and therefore no current can flow to the laser element LD. The soft start capacitor 38 is charged to the power source voltage level. The laser element LD does not emit light, and no current is generated by the photo-detection element PD, and therefore, the input voltage of the non-inversion input terminal of the feedback amplifier 12 is at the ground level, and the feedback amplifier 12 outputs the ground level. Consequently, the sink current (for example, about 100 μA) of the feedback amplifier 12 flows unchanged through the emission stop switch 29, but, as previously described, the current drive capacity of the emission stop switch 29 is sufficiently high, and therefore, the gate voltage of the emission control switch 11 is maintained at the power source voltage level.

Next, when the counter 22, which has begun to count, counts up (for example, a count of about 4) to a predetermined time (for example, about 0.1 msec) that is shorter than one cycle of the intermittent control signal SIG (for example, 20 msec), a high level is input to the set input S of the flip flop circuit 23. The low level from the inversion output QN of the flip flop circuit 23 is input to the NOR circuit 28 of the emission control switch controlling circuit 16. Moreover, the low level from the non-inversion output Q of the flip flop circuit 20 of the fail-safe circuit 13, which was reset, is input to the other input terminal of the NOR circuit 28. The NOR circuit 28 outputs the high level, and causes the emission stop switch 29 to turn OFF. Further, during the predetermined time (for example, about 0.1 msec) determined by the counter 22, the inner power source VddIN rises sufficiently and the soft start capacitor 38 fully charges.

Then, the electric charge charged at the soft start capacitor 38 (for example, 0.01 μF) is gradually discharged by the sink current (for example, about 100 μA) of the feedback amplifier 12, and the gate voltage of the emission control switch 11 gradually drops. In this way, the emission control switch controlling circuit 16 controls the emission control switch 11 to gradually increase the current that flows to the laser element LD when the laser element LD begins to emit light.

In this way, the laser element driving apparatus 1 can prevent the deleterious affect of high intensity light emission on the human eye by gradually increasing the current which flows to the laser element LD and causing no rush current to flow to the laser element LD when the laser element LD begins to emit. Moreover, long-lasting laser element life may be expected because stress on the laser element caused by the rush current is minimized.

Next, the emission intensity of the laser element LD gradually increases in conjunction with the gradual decrease of the gate voltage of the emission control switch 11. Then, the current that the photo-detection element PD generates becomes large, and the voltage of the voltage conversion resistor 30 gradually heightens. If this voltage becomes larger than the output voltage of the emission intensity setting voltage generator 24, the feedback amplifier 12 outputs, causing the gate voltage of the emission control switch 11 to rise. Specifically, when the voltage of the voltage conversion resistor 30 and the output voltage of the emission intensity setting voltage generator 24 coincide, the predetermined current stably flows to the laser element LD based on a feedback loop.

The operation described above is repeated corresponding to the intermittent control signal SIG. Then, the laser element LD is made to emit discontinuously (intermittently) in a stable manner so as to prevent a deleterious affect on human eyes.

Here, if trouble occurs with the intermittent control signals SIG or the like, and the inner power source VddIN does not fall within a predetermined time (for example, about 0.1 sec), the counter 19 of the fail-safe circuit 13 reaches the predetermined count number (for example, a count of about 4000). In this case, a high level is input to the set input S of the flip flop circuit 20, and the high level from the non-inversion output Q is input to the NOR circuit 28 of the emission control switch controlling circuit 16. Then, the low level from the NOR circuit 28 is input to the emission stop switch 29, and the emission stop switch 29 is turned ON. The emission control switch 11 is thereby turned OFF, a current does not flow to the laser element LD, and emission stops. Specifically, a current flowing continuously to the laser element LD for a predetermined time (for example, about 0.1 sec) from the time the laser element LD begins to emit light is judged to be abnormal, and the emission control switch 11 is turned OFF to stop emission of the laser element LD.

In this way, if the laser element LD continues to emit light for a predetermined time or more based on a trouble with the intermittent control signal SIG or the like, by turning OFF the emission control switch 11 and stopping the emission of the laser element LD, the laser element driving apparatus 1 can safely drive the laser element LD to prevent a deleterious affect on human eyes even during abnormal operation.

Moreover, during abnormal operation, the low level from the inversion output QN of the flip flop circuit 20 is input to the oscillator 17, stopping the oscillation operation. This is because it is not necessary for the oscillator to operate if the laser element LD is not allowed to emit light. In this way, it is possible to economize on power consumption.

The present invention is not limited to the embodiment described above, and a variety of design modifications are possible within the range of the items described in the claims. For example, in the above embodiment an apparatus having both a fail-safe circuit 13 and a soft start circuit 14 were explained, but the former may be omitted if countermeasures to prevent a trouble with the intermittent control signal SIG or the like are taken by another means; and the latter may be omitted if countermeasures to prevent a rush current to the laser element LD are taken by another means. Moreover, naturally it is possible to increase or decrease the number of inverters or NOR circuits and the like by substituting the MOS transistor used in the laser element driving apparatus 1 with a bipolar transistor, or conversely, by replacing the bipolar transistor with a MOS transistor.

1-10. (canceled)

11. A laser element driving apparatus comprising:
a laser element arranged to vary a light intensity corresponding to a current that flows thereto;
a photodetection element arranged to monitor and convert the light intensity of the laser element to electric signals;
an emission control switch arranged to control the current flowing to the laser element;
a feedback amplifier arranged to control the emission control switch by feeding back electric signals of the photodetection element; and
an emission control switch controlling circuit arranged to determine as abnormal a current flowing continuously to the laser element for a predetermined time from the beginning of light emission of the laser element, and to turn OFF the emission control switch.

12. A laser element driving apparatus comprising:
a laser element arranged to vary a light intensity corresponding to a current that flows thereto;
a photodetection element arranged to monitor and convert the light intensity of the laser element to electric signals;
an emission control switch arranged to control the current flowing to the laser element;
a feedback amplifier arranged to control the emission control switch by feeding back electric signals of the photodetection element; and
an emission control switch controlling circuit arranged to control the emission control switch such that the current flowing to the laser element, when the laser element begins to emit light, is gradually increased.

13. The laser element driving apparatus according to claim 12, wherein the emission control switch controlling circuit is arranged to determine as abnormal a current flowing continuously to the laser element for a predetermined time from the beginning of light emission of the laser element, and to turn OFF the emission control switch.

14. The laser element driving apparatus according to claim 12, wherein the emission control switch controlling circuit includes a capacitor and an emission stop switch and arranged such that when the laser element begins to emit light, the emission control switch is forced to turn OFF and the capacitor is charged by turning the emission stop switch ON, and after a predetermined time has elapsed, the emission control switch is controlled by turning the emission stop switch OFF and discharging the capacitor, and then the current flowing to the laser element is gradually increased.

15. The laser element driving apparatus according to claim 14, wherein the emission control switch controlling circuit is arranged to determine as abnormal a current flowing continuously to the laser element for a predetermined time from the beginning of light emission of the laser element, and to turn OFF the emission control switch by turning ON the emission stop switch.

16. The laser element driving apparatus according to claim 11, wherein the emission control switch controlling circuit includes an emission stop switch, and is arranged to turn OFF the emission control switch by turning ON the emission stop switch.

17. The laser element driving apparatus according to claim 15, further comprising an oscillator arranged to output a reference clock for counting the predetermined time from the beginning of light emission of the laser element up to the determination of abnormality, wherein oscillation of the oscillator is stopped when the abnormality has been determined.

18. The laser element driving apparatus according to claim 17, further comprising a power source switch arranged between a power source and an inner power source, and which opens and closes corresponding to intermittent control signals, wherein the inner power source supplies power to the emission control switch, the feedback amplifier, and the emission stop switch, and a current drive capacity of the emission stop switch is higher than a current drive capacity of a sink current side on the feedback amplifier.

19. The laser element driving apparatus according claim 18, further comprising a fail-safe circuit which includes a counter arranged to start from a rise of the inner power source, and to count the number of the reference clock of the oscillator, wherein when the counter reaches the predetermined count, the fail-safe circuit is arranged to determine an abnormality and output a signal that causes the emission stop switch to turn ON.

20. The laser element driving apparatus according claim 18, further comprising a soft-start circuit which includes a counter arranged to start from the change of the intermittent control signal when the power source switch is closed, and counts the number of the reference clock of the oscillator, wherein when the counter reaches the predetermined count, the soft-start circuit outputs a signal that turns OFF the emission stop switch so that the capacitor of the emission control switch controlling circuit discharges.

21. The laser element driving apparatus according to claim 16, further comprising an oscillator arranged to output a reference clock for counting the predetermined time from the beginning of light emission of the laser element up to the determination of abnormality, wherein oscillation of the oscillator is stopped when the abnormality has been determined.

22. The laser element driving apparatus according to claim 21, further comprising a power source switch arranged between a power source and an inner power source, and which opens and closes corresponding to intermittent control signals, wherein the inner power source supplies power to the emission control switch, the feedback amplifier, and the emission stop switch, and a current drive capacity of the emission stop switch is higher than a current drive capacity of a sink current side on the feedback amplifier.

23. The laser element driving apparatus according claim 22, further comprising a fail-safe circuit which includes a counter arranged to start from a rise of the inner power source, and to count the number of the reference clock of the oscillator, wherein when the counter reaches the predetermined count, the fail-safe circuit is arranged to determine an abnormality and output a signal that causes the emission stop switch to turn ON.

24. The laser element driving apparatus according claim 22, further comprising a soft-start circuit which includes a counter arranged to start from the change of the intermittent control signal when the power source switch is closed, and counts the number of the reference clock of the oscillator, wherein when the counter reaches the predetermined count, the soft-start circuit outputs a signal that turns OFF the emission stop switch so that a capacitor of the emission control switch controlling circuit discharges.
